(19) United States
(12) Patent Application Publication
(10) Pub. No.: US 2020/0235619 A1
(43) Pub. Date: Jul. 23, 2020

(54) ROTOR

(71) Applicant: HONDA MOTOR CO., LTD., Tokyo (JP)

(72) Inventor: Kenta Uchida, Wako-shi (JP)

(21) Appl. No.: 16/736,854

(22) Filed: Jan. 8, 2020

(30) Foreign Application Priority Data
Jan. 17, 2019 (JP) 2019-006126

(51) Int. Cl. H02K 1/27; H02K 15/03; H02K 1/04

(52) U.S. Cl. CPC H02K 1/276; H02K 1/04; H02K 15/03

(57) ABSTRACT

A rotor includes a rotor core having a magnet insertion slot, a set of magnet pieces accommodated in the magnet insertion slot; and a single insulating sheet wound around the magnet pieces. The insulating sheet is disposed between the magnet pieces and the rotor core and between the magnet pieces adjacent to each other, and at least a portion of the insulating sheet has adhesiveness and foamability.

### CROSS-REFERENCE TO RELATED APPLICATION

Priority is claimed on Japanese Patent Application No. 2019-006126, filed Jan. 17, 2019, the content of which is incorporated herein by reference.

### BACKGROUND OF THE INVENTION

### Field of the Invention

The present invention relates to a rotor.

### Description of Related Art

Conventionally, a permanent magnet embedded rotor in which permanent magnets are embedded in a rotor core is used as a rotor of a rotary electric machine. In such a rotor, various techniques for bonding and fixing the rotor and the permanent magnets have been proposed in order to inhibit vibration and cracking of the magnets during rotation of the rotor.

For example, Japanese Unexamined Patent Application, First publication No. 2010-141989 (hereinafter referred to as Patent Document 1) discloses a configuration in which a rotor core formed with a plurality of holes and permanent magnets inserted into the holes are provided, each permanent magnet is divided into at least two or more pieces, and a magnet fixing means whose thickness increases after insertion when the magnet is inserted into the hole, thereby pressing each magnet against an inner wall surface of the hole is provided between the magnet pieces. According to the technique disclosed in Patent Document 1, the magnet fixing means is thermally expanded after insertion of the magnet into the hole to increase the thickness so that each magnet piece can be pressed against the inner wall surface of the hole and the permanent magnet can be fixed to the hole without rattling.

Japanese Unexamined Patent Application, First publication No. 2012-244838 (hereinafter referred to as Patent Document 2) discloses a configuration in which electrically insulating adhesive layers provided between one surface and another surface of a permanent magnet and an inner wall surface of a magnet insertion hole fix the permanent magnet in the magnet insertion hole. A high magnetic permeability material is mixed into the adhesive layer. According to the technique disclosed in Patent Document 2, since the adhesive layers electrically insulate between the magnet and a rotor core, it is possible to prevent a large eddy current loop path from being formed via the magnet, thereby inhibiting an eddy current loss.

### SUMMARY OF THE INVENTION

However, in the technique disclosed in Patent Document 1, since the magnets are pressed against the rotor core and fixed thereto, there is a possibility that insulation between the rotor core and the magnets may not be ensured. Therefore, an eddy current loss may occur when the magnets and the rotor core conduct. In addition, for example, in the case in which this is applied to a rotor core formed by laminating a plurality of steel plates, since the steel plate which protrudes furthest to the hole side abuts the magnet, a large stress is generated between some steel plates and the magnets. For this reason, there is a concern that a large stress may act on the magnets due to a centrifugal force when the rotor rotates and thus the magnets may break.

In the technique disclosed in Patent Document 2, since it is required to attach the adhesive layer to each surface of the magnet, effort is required for the attachment operation. Especially, in the case in which magnet pieces are used, since it is required to attach the adhesive layer not only between the rotor core and the magnet but also between the magnets, there is a concern regarding the number of operations increasing as the number of pieces of the magnet increases.

Aspects of the present invention have been made in view of the above circumstances, and it is an object of the present invention to provide a high-performance rotor in which magnets are fixed to a rotor core with a simple configuration, the rotor core and the magnets are insulated, and cracking of the magnets is inhibited.

In order to solve the above problems and achieve the object, the present invention adopts the following aspects.

(1) A rotor according to an aspect of the present invention includes a rotor core having a magnet insertion slot, a set of magnet pieces accommodated in the magnet insertion slot, and a single insulating sheet wound around the magnet pieces, in which the insulating sheet is disposed between the magnet pieces and the rotor core and between the magnet pieces adjacent to each other, and at least a portion of the insulating sheet has adhesiveness and foamability.

(2) In the above aspect (1), the insulating sheet may have a sheet layer which insulates the magnet pieces from the rotor core and the adjacent magnet pieces from each other, and an adhesive layer which bonds and fixes the magnet pieces to the rotor core and the adjacent magnet pieces to each other, and the adhesive layer may have foamability.

(3) In the above aspect (2), the adhesive layer may be provided on a portion of the sheet layer.

(4) In any one of the above aspects (1) to (3), the insulating sheet may be wound in a B shape when viewed in an axial direction of the rotor core.

(5) In any one of the above aspects (1) to (3), the insulating sheet may be wound in an S shape when viewed in an axial direction of the rotor core.

According to the above aspect (1), the insulating sheet insulates between the magnet pieces and the rotor core and between the magnet pieces adjacent to each other. Thus, occurrence of an eddy current loss is inhibited and thus performance of the rotor can be improved. In addition, since at least a portion of the insulating sheet has foamability, the insulating sheet foams and expands, thereby pressing the magnet pieces against the rotor core and the adjacent magnet pieces against each other. Further, since at least a portion of the insulating sheet has adhesiveness, the pressed magnet pieces and the rotor core and the adjacent magnet pieces are bonded to each other. Thus, the magnet pieces can be reliably fixed to the rotor core. On the other hand, by placing the foamed insulating sheet between the rotor core and the magnet pieces as a cushioning material, it is possible to inhibit an excessive stress from acting on the magnet pieces. Therefore, cracking of the magnet pieces can be inhibited.

Since the magnet pieces are fixed to the rotor core by winding the single insulating sheet therearound, the operation can be easily performed as compared with the case in which an adhesive is applied to each surface of the magnet pieces.

Therefore, it is possible to provide a high-performance rotor in which the magnets are fixed to the rotor core with a simple configuration, the rotor core and the magnets are insulated, and cracking of the magnets is inhibited.

According to the above aspect (2), since the insulating sheet has the sheet layer and the adhesive layer, the sheet layer insulates the magnet pieces from the rotor core and the adjacent magnet pieces from each other, and the adhesive layer bonds the magnet pieces to the rotor core and the adjacent magnet pieces to each other. Therefore, insulation and bonding can be performed by a single insulating sheet. In addition, since the adhesive layer has foamability, pressing and bonding can be performed simultaneously by foaming the adhesive layer. Therefore, it is possible to more reliably bond and fix the magnet pieces to the rotor core and the magnet pieces to each other.

According to the above aspect (3), since the adhesive layer is provided on a portion of the sheet layer, a cost of the insulating sheet can be reduced by providing the adhesive layer only at necessary locations.

Also, an arrangement of the adhesive layer can be changed in accordance with shapes and the number of pieces of the magnet pieces, thereby improving versatility.

According to the above aspect (4), since the insulating sheet is wound in a B shape when viewed in the axial direction of the rotor core, it is possible to reliably insulate the magnet pieces from the rotor core and the magnet pieces from each other.

According to the above aspect (5), since the insulating sheet is wound in an S shape when viewed in the axial direction of the rotor core, an amount of insulating sheet used can be reduced as compared with the case in which it is wound in a B shape. Therefore, reduction in cost for the insulating sheet can be achieved.

### BRIEF DESCRIPTION OF THE DRAWINGS

FIG. 1 is a front view of a rotor according to a first embodiment.

FIG. 2 is an enlarged view of section II of FIG. 1.

FIG. 3 is a cross-sectional view taken along line III-III of FIG. 2.

FIG. 4 is an explanatory view showing a manufacturing method of the rotor according to the first embodiment.

FIG. 5 is an explanatory view showing a manufacturing method of a rotor according to a first modified example.

FIG. 6 is a partially enlarged view of a rotor according to a second embodiment.

FIG. 7 is a configurational view of an outer surface of an insulating sheet according to the second embodiment.

FIG. 8 is a configurational view of an inner surface of the insulating sheet according to the second embodiment.

FIG. 9 is a partially enlarged view of a rotor according to a third embodiment.

FIG. 10 is a partially enlarged view of a rotor according to a fourth embodiment.

FIG. 11 is a partially enlarged view of a rotor according to a conventional technique.

FIG. 12 is a cross-sectional view taken along line XII-XII of FIG. 11.

### DETAILED DESCRIPTION OF THE INVENTION

Hereinafter, embodiments of the present invention will be described with reference to the drawings.

### First Embodiment

(Rotor)

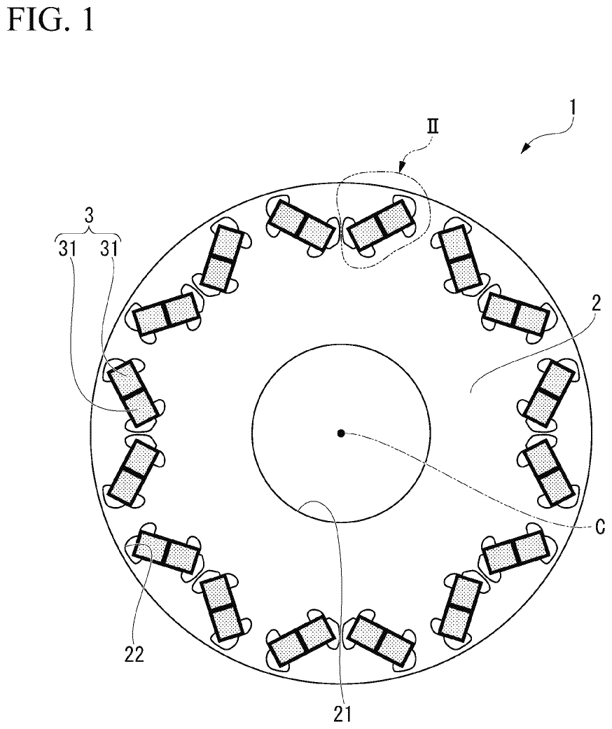

FIG. 1 is a front view of a rotor 1 according to a first embodiment when viewed in an axial direction thereof. The rotor 1 is, for example, a rotor 1 of a rotary electric machine mounted on a vehicle such as a hybrid vehicle or an electric vehicle.

However, a configuration of the rotor 1 of the present invention is not limited to a traction motor, but can also be applied to a generator motor, a motor for other uses, and a rotor 1 for a rotary electric machine (including a generator) other than for a vehicle.

As shown in FIG. 1, the rotor 1 is formed in an annular shape centering on an axis C. The axis C extends in a direction penetrating a paper surface of FIG. 1. In the following description, a direction along the axis C of the rotor 1 may be simply referred to as an axial direction, a direction orthogonal to the axis C may be referred to as a radial direction, and a direction around the axis C may be referred to as a circumferential direction.

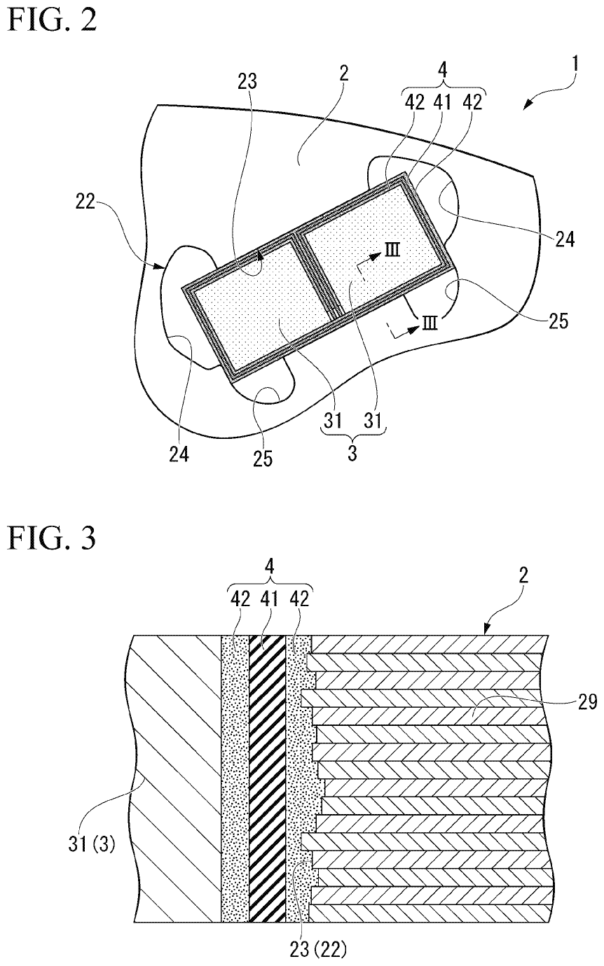

A stator (not shown) is disposed outward in the radial direction from the rotor 1 with an interval therebetween. The rotor 1 is configured to be rotatable around the axis C with respect to the stator. The rotor 1 includes a rotor core 2, magnet pieces 3, and an insulating sheet 4 (see FIG. 2).

(Rotor Core)

The rotor core 2 is formed in an annular shape around the axis C. The rotor core 2 is formed in a columnar shape extending in the axial direction by laminating a plurality of steel plates 29 in the axial direction. The rotor core 2 has a shaft insertion hole 21 and magnet insertion slots 22.

The shaft insertion hole 21 is formed coaxially with the axis C. The shaft insertion hole 21 penetrates the rotor core 2 in the axial direction. A rotation shaft (not shown) is fixed to the shaft insertion hole 21 while penetrating therethrough. Thus, the rotor core 2 and the rotation shaft rotate integrally around the axis C.

FIG. 2 is an enlarged view of section II of FIG. 1. The magnet insertion slots 22 are provided in an outer peripheral portion of the rotor core 2. The magnet insertion slots 22 penetrate the rotor core 2 in the axial direction. A plurality of (sixteen in the present embodiment) magnet insertion slots 22 are provided in the circumferential direction. As shown in FIG. 1, the magnet insertion slot 22 is configured such that a pair of magnet insertion slots 22 are disposed in a V shape when viewed in the axial direction. As shown in FIG. 2, the magnet insertion slot 22 has a magnet insertion portion 23, gap portions 24, and stress relief portions 25.

The magnet insertion portion 23 accommodates the magnet pieces 3, which will be described later. The magnet insertion portion 23 is formed in a rectangular shape.

A pair of gap portions 24 are provided at both ends of the magnet insertion portion 23 in a longitudinal direction thereof. The gap portions 24 protrude from shorter sides of the magnet insertion portion 23 toward the rotor core 2 side. The gap portions 24 communicate with the magnet insertion portion 23.

The stress relief portions 25 are provided at positions corresponding to corner portions of the magnet pieces 3 accommodated in the magnet insertion portion 23. A pair of the stress relief portions 25 are formed to protrude toward a radially inner side of the rotor core 2 from positions corresponding to the corner portions of the magnet pieces 3 in a longer side of the magnet insertion portion 23 on a radially inner side thereof. The stress relief portions 25 communicate with the magnet insertion portion 23.

The gap portions 24 and the stress relief portions 25 communicate with the magnet insertion portion 23, whereby one hole (that is, the magnet insertion slot 22) penetrating the rotor core 2 in the axial direction is formed in the rotor core 2.

(Magnet Pieces)

The magnet pieces 3 are accommodated in the magnet insertion portion 23. The magnet pieces 3 extend in the axial direction inside the rotor core 2. A plurality of (sixteen in the present embodiment) magnet pieces 3 are disposed in the circumferential direction while being accommodated in the magnet insertion portions 23. The magnet pieces 3 are disposed such that different magnetic poles are alternately positioned in the circumferential direction of the rotor core 2. The magnet pieces 3 are formed in rectangular shapes when viewed in the axial direction. The magnet pieces 3 are divided into two single magnets 31. Specifically, the magnet pieces 3 are divided into rectangular single magnets 31 and 31 that are vertically bisected at a longitudinal center position of the magnet pieces 3.

The magnet piece 3 is, for example, a rare earth magnet. As the rare earth magnet, for example, a neodymium magnet, a samarium cobalt magnet, a praseodymium magnet, and the like may be exemplified.

(Insulating Sheet)

The insulating sheet 4 is wound around the magnet pieces 3. A single insulating sheet 4 is accommodated in one magnet insertion slot 22. Inside the magnet insertion slot 22, the insulating sheet 4 is disposed between the magnet pieces 3 and the rotor core 2 and between the magnet pieces 3 adjacent to each other

At least a portion of the insulating sheet 4 has adhesiveness and foamability. Specifically, the insulating sheet 4 includes a sheet layer 41 and adhesive layers 42.

FIG. 3 is a cross-sectional view taken along line III-III of FIG. 2.

The sheet layer 41 is disposed between the magnet pieces 3 and the rotor core 2 and between the magnet pieces 3 adjacent to each other. The sheet layer 41 insulates the magnet pieces 3 from the rotor core 2 and the adjacent magnet pieces 3 from each other. The sheet layer 41 is an insulating resin such as polyester, epoxy, and polyimide.

The adhesive layers 42 are provided on both surfaces of the sheet layer 41. The adhesive layers 42 are applied to almost the entire surfaces of the sheet layer 41. The adhesive layers 42 bond and fix the magnet pieces 3 to the rotor core 2 and the adjacent magnet pieces 3 to each other. The adhesive layer 42 has foamability. Specifically, the adhesive layer 42 has a property of expanding in volume when heated. The adhesive layer 42 is, for example, an acryl-based adhesive, a rubber-based adhesive, a silicone-based adhesive, and the like.

The magnet pieces 3 are bonded and fixed to the rotor core 2 using the adhesive layers 42.

Returning to FIG. 2, the insulating sheet 4 formed in this way is wound around the magnet pieces 3 in a B shape when viewed in the axial direction of the rotor core 2. Specifically, the insulating sheet 4 is wound around one single magnet 31 with one end portion thereof disposed on a dividing surface of the magnet pieces 3, and then is wound around the other single magnet 31 in a direction the same as a winding direction of the one single magnet 31, and the other end portion thereof is again disposed on a dividing surface of the magnet pieces 3. Thus, both end portions of the insulating sheet 4 are disposed on the dividing surfaces of the magnet pieces 3.

Next, a method for mounting the magnet pieces 3 and the insulating sheet 4 on the rotor core 2 will be described.

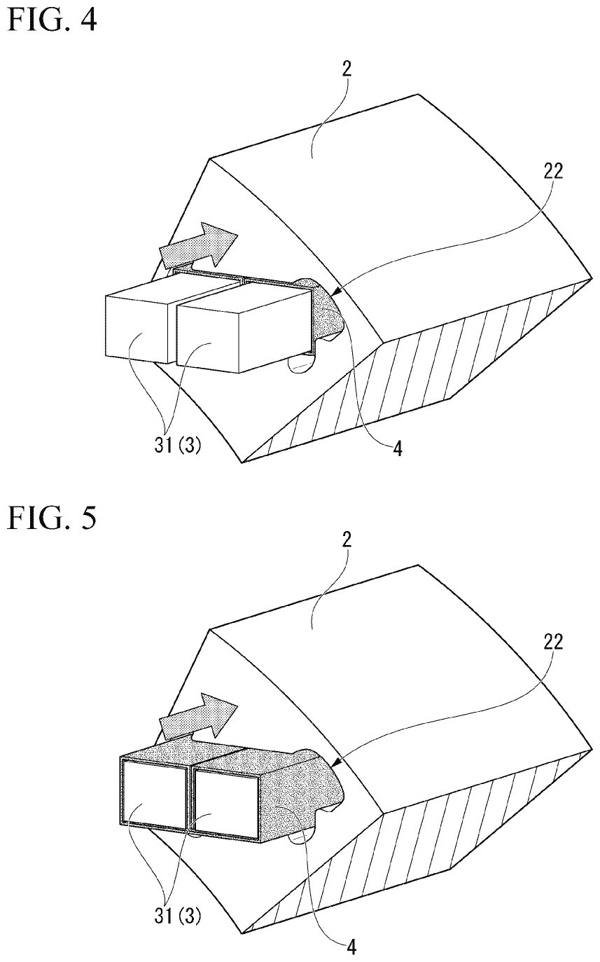

FIG. 4 is an explanatory view showing a manufacturing method of the rotor 1.

As shown in FIG. 4, first, the insulating sheet 4 bent into a predetermined shape is inserted into the magnet insertion slot 22 of the rotor core 2. The insulating sheet 4 is bent such that it has a shape that allows the magnet pieces 3 to be inserted therethrough. Next, the magnet pieces 3 are inserted into the insulating sheet 4 accommodated in the rotor core 2. Specifically, the single magnets 31 are respectively inserted into two spaces formed by the insulating sheet 4. Thus, the magnet pieces 3 and the insulating sheet 4 are disposed in the rotor core 2.

Next, the insulating sheet 4 is heated to foam the adhesive layers 42 (see FIG. 3). Thus, the adhesive layers 42 press the magnet pieces 3 and the rotor core 2 and bond and fix the magnet pieces 3 to the rotor core 2 and the adjacent magnet pieces 3 to each other.

In this way, the rotor 1 is manufactured by fixing the magnet pieces 3 and the insulating sheet 4 to the rotor core 2.

(Operations and Effects)

Next, operations and effects of the rotor 1 will be described.

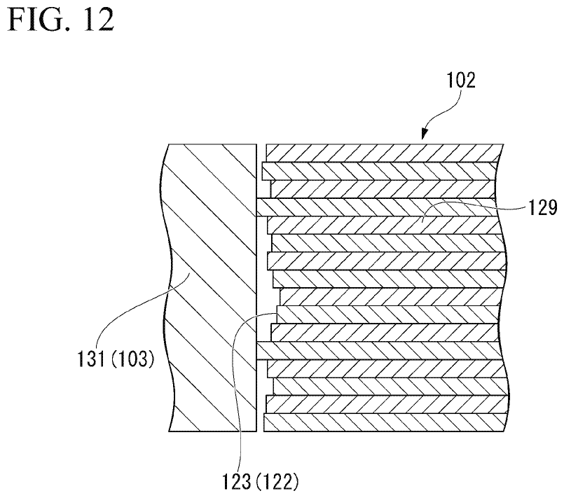

Here, FIG. 11 is a partially enlarged view of the vicinity of a magnet insertion slot 122 of a rotor 101 according to a conventional technique. FIG. 12 is a cross-sectional view taken along line XII-XII of FIG. 11.

As shown in FIG. 11, in the conventional technique in which the insulating sheet 4 (see FIG. 2) is not disposed between magnet pieces 103 and a rotor core 102 and between the magnet pieces 103 adjacent to each other, for example, the magnet pieces 103 are fixed to the rotor core 102 by pouring a resin into the magnet insertion slot 122 in which the magnet pieces 103 are accommodated. An adhesive is applied to a dividing surface of the magnet pieces 103. As shown in FIG. 12, since the rotor core 102 is formed by laminating a plurality of steel plates 129, an uneven shape is formed on an inner wall surface of the magnet insertion slot 122 due to level differences between the steel plates 129. In this state, when the rotor 101 rotates, some steel plates 129 and the magnet pieces 103 are brought into contact with each other due to a centrifugal force, and thus excessive stress is easily generated at a portion of the magnet pieces 103. As a result, there is a concern that cracking of the magnet pieces 103 may occur.

In addition, in the case in which the magnet pieces 103 and the rotor core 102 are in contact with each other, there is a concern that a loss may occur due to occurrence of eddy current flowing inside the magnet pieces 103, thereby degrading performance of the rotor 101.

Similarly, in the case in which, for example, a metal piece or the like is incorporated between the single magnets 131 or the single magnets 131 are obliquely disposed in the axial direction, there is a concern that the single magnets 131 may be electrically connected to each other to cause a loss.

Accordingly, in the conventional technique, problems remain in terms of inhibiting cracking of the magnet pieces 103 and ensuring insulation between the rotor core 102 and the magnet pieces 103 and between the magnet pieces 103.

Returning to FIG. 2, according to the rotor 1 of the present embodiment, the insulating sheet 4 insulates the magnet pieces 3 from the rotor core 2 and the adjacent magnet pieces 3 from each other. Thus, occurrence of an eddy current loss can be inhibited, thereby improving performance of the rotor 1. In addition, since at least a portion of the insulating sheet 4 has foamability, the insulating sheet 4 foams and expands, thereby pressing the magnet pieces 3 against the rotor core 2 and the adjacent magnet pieces 3 against each other. Further, since at least a portion of the insulating sheet 4 has adhesiveness, the pressed magnet pieces 3 and the rotor core 2 and the adjacent magnet pieces 3 are bonded to each other. Thus, the magnet pieces 3 can be reliably fixed to the rotor core 2. On the other hand, since the foamed insulating sheet 4 is disposed between the rotor core 2 and the magnet pieces 3 as a cushioning material, it is possible to inhibit excessive stress from acting on the magnet pieces 3. Therefore, cracking of the magnet pieces 3 can be inhibited.

Since the magnet pieces 3 are fixed to the rotor core 2 by winding a single insulating sheet 4 therearound, the operation can be easily performed as compared with the case in which an adhesive is applied to each surface of the magnet pieces 3.

Accordingly, it is possible to provide a high-performance rotor 1 in which the magnet pieces 3 are fixed to the rotor core 2 with a simple configuration, the rotor core 2 and the magnet pieces 3 are insulated, and cracking of the magnet pieces 3 are inhibited.

Moreover, since the magnet pieces 3 and the rotor core 2 can be bonded and fixed using the insulating sheet 4, there is no need to pour a resin into the magnet insertion slot 22 for resin molding. Therefore, the number of manufacturing steps and manufacturing costs can be reduced.

Since the insulating sheet 4 has the sheet layer 41 and the adhesive layers 42, the sheet layer 41 insulates the magnet pieces 3 from the rotor core 2 and the magnet pieces 3 from each other, and the adhesive layers 42 bond the magnet pieces 3 to the rotor core 2 and the magnet pieces 3 to each other. Therefore, a single insulating sheet 4 can serve for both insulation and adhesion. Further, since the adhesive layers 42 have foamability, pressing and adhesion can be performed simultaneously by foaming the adhesive layers 42. Therefore, the magnet pieces 3 and the rotor core 2 and the magnet pieces 3 themselves can be more reliably bonded and fixed to each other.

Since the insulating sheet 4 is wound in a B shape when viewed in the axial direction of the rotor core 2, it is possible to reliably insulate the magnet pieces 3 from the rotor core 2 and the magnet pieces 3 from each other.

### FIRST MODIFIED EXAMPLE

Next, a first modified example according to the present invention will be described. FIG. 5 is an explanatory view showing a manufacturing method of a rotor 1 according to a first modified example. The present example is different from the above-described embodiment in that the insulating sheet 4 is first wound around the magnet pieces 3 and then inserted into the rotor core 2.

In the present example, first, the insulating sheet 4 is wound around the magnet pieces 3. Next, the magnet pieces 3 around which the insulating sheet 4 is wound are inserted into the magnet insertion slot 22 of the rotor core 2. Thus, the magnet pieces 3 and the insulating sheet 4 are disposed in the rotor core 2.

Next, the insulating sheet 4 is heated to foam the adhesive layers 42. Thus, the adhesive layers 42 press the magnet pieces 3 and the rotor core 2 and bond and fix the magnet pieces 3 to the rotor core 2 and the adjacent magnet pieces 3 to each other.

In this way, the rotor 1 is manufactured by fixing the magnet pieces 3 and the insulating sheet 4 to the rotor core 2.

According to the present example, the same operations and effects as in the first embodiment can be obtained, and since the magnet pieces 3 and the insulating sheet 4 are integrated in advance, the magnet pieces 3 and the insulating sheet 4 can be reliably bonded to each other.

### Second Embodiment

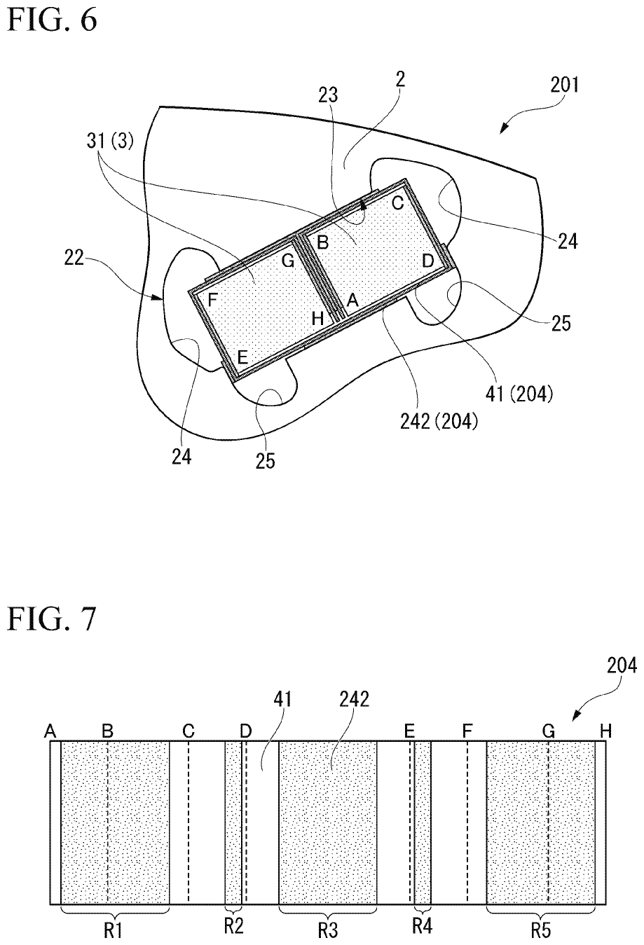

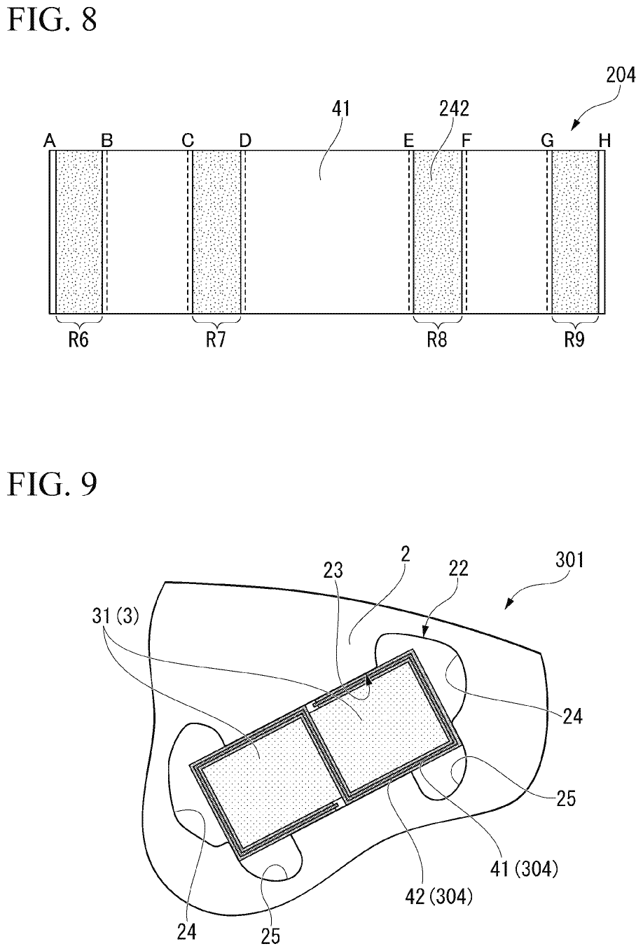

Next, a second embodiment according to the present invention will be described. FIG. 6 is a partially enlarged view of the vicinity of the magnet insertion slot 22 of a rotor 201 according to the second embodiment. FIG. 7 is a configurational view of an outer surface of an insulating sheet 204. FIG. 8 is a configurational view of an inner surface of the insulating sheet 204. The present embodiment is different from the above-described embodiment in that an adhesive layer 242 is provided on a portion of the sheet layer 41.

In the present embodiment, the adhesive layer 242 is provided on a portion of the sheet layer 41. Specifically, as shown in FIG. 7, the sheet layer 41 is formed in a single rectangular sheet shape as in the first embodiment. As shown in FIG. 7, the adhesive layer 242 is applied in a stripe shape to an outer surface of the sheet layer 41 (an outer side at the time of winding, that is, a surface facing the rotor core 2 side). Also, as shown in FIG. 8, the adhesive layer 242 is applied in a stripe shape to an inner surface of the sheet layer 41 (an inner side at the time of winding, that is, a surface facing the magnet pieces 3 side). Here, as shown in FIG. 6, four corners of one single magnet 31 are defined as a corner portion A, a corner portion B, a corner portion C, and a corner portion D in the order in which the insulating sheet 204 is wound. Also, four corners of the other single magnet 31 are defined as a corner portion E, a corner portion F, a corner portion G, and a corner portion H in the order in which the insulating sheet 204 is wound.

As shown in FIG. 7, on the outer surface of the sheet layer 41, the adhesive layer 242 is applied to a first region R1 including the corner portion B, a second region R2 in the vicinity of the corner portion D, a third region R3 positioned in an intermediate portion between the corner portion D and the corner portion E, and a fourth region R4 in the vicinity of the corner portion E, and a fifth region R5 including the corner portion G.

As shown in FIGS. 6 and 7, the first region R1 is a region in which a dividing surface of the magnet pieces 3 is included and a longer side of the magnet pieces 3 on a radially outer side thereof and the rotor core 2 face each other in the state in which the magnet pieces 3 are accommodated in the magnet insertion slot 22. The second region R2 is a region in which a shorter side of the magnet pieces 3 on the radially outer side and the rotor core 2 face each other. The third region R3 is a region in which a longer side of the magnet pieces 3 on a radially inner side thereof and the rotor core 2 face each other. The fourth region R4 is a region in which a shorter side of the magnet pieces 3 on the radially inner side and the rotor core 2 face each other. In this way, the adhesive layer 242 is provided only in the regions in which the insulating sheet 204 and the rotor core 2 are in contact with each other on the outer surface of the sheet layer 41.

As shown in FIG. 8, on the inner surface of the sheet layer 41, the adhesive layer 242 is applied to a sixth region R6 between the corner portions A and B, a seventh region R7 between the corner portions C and D, an eighth region R8 between the corner portions E and F, and a ninth region R9 between the corner portions G and H.

As shown in FIGS. 6 and 8, the sixth region R6 is a region corresponding to a dividing surface of one single magnet 31 in the state in which the magnet pieces 3 are accommodated in the magnet insertion slot 22. The seventh region R7 is a region corresponding to the shorter side of the magnet pieces 3 on the radially outer side. The eighth region R8 is a region corresponding to the shorter side of the magnet pieces 3 on the radially inner side. The sixth region R6 is a region corresponding to a dividing surface of the other single magnet 31. In this way, the adhesive layer 242 is provided at some portions of the regions in which the insulating sheet 204 and the magnet pieces 3 are in contact with each other on the inner surface of the sheet layer 41.

According to the present embodiment, since the adhesive layer 242 is provided on a portion of the sheet layer 41, the adhesive layer 242 can be provided only at necessary locations, thereby reducing the cost of the insulating sheet 204. In addition, an arrangement of the adhesive layer 242 can be changed in accordance with shapes and the number of pieces of the magnet pieces 3, thereby improving versatility.

As shown in FIG. 6, since the adhesive layer 242 is disposed in the regions corresponding to the corner portions D and E (second region R2 and fourth region R4 in FIG. 7), deformation of the magnet insertion slot 22 resulting from a centrifugal force during rotation can be inhibited. Therefore, protrusion of the rotor core 2 due to a centrifugal force can be inhibited.

### Third Embodiment

Next, a third embodiment according to the present invention will be described. FIG. 9 is a partially enlarged view of the vicinity of the magnet insertion slot 22 of a rotor 301 according to the third embodiment. The present embodiment is different from the above-described embodiments in that an insulating sheet 304 is wound in an S shape.

In the present embodiment, the insulating sheet 304 is wound around the magnet pieces 3 in an S shape when viewed in the axial direction of the rotor core 2. Specifically, the insulating sheet 304 is wound around one single magnet 31 with one end portion thereof disposed between the one single magnet 31 and an inner wall surface of the rotor core 2 on the radially outer side, and then is wound around the other single magnet 31 in a direction opposite to the winding direction of the one single magnet 31, and the other end portion thereof is disposed between the other single magnet 31 and an inner wall surface of the rotor core 2 on the radially inner side. Thus, the insulating sheet 304 is disposed between the magnet pieces 3 and the rotor core 2 and between the magnet pieces 3 themselves without overlapping each other.

According to the present embodiment, since the insulating sheet 304 is wound in an S shape when viewed in the axial direction of the rotor core 2, an amount of the insulating sheet 304 used can be reduced as compared with the case in which it is wound in a B shape. Therefore, reduction in cost for the insulating sheet 304 can be achieved.

### Fourth Embodiment

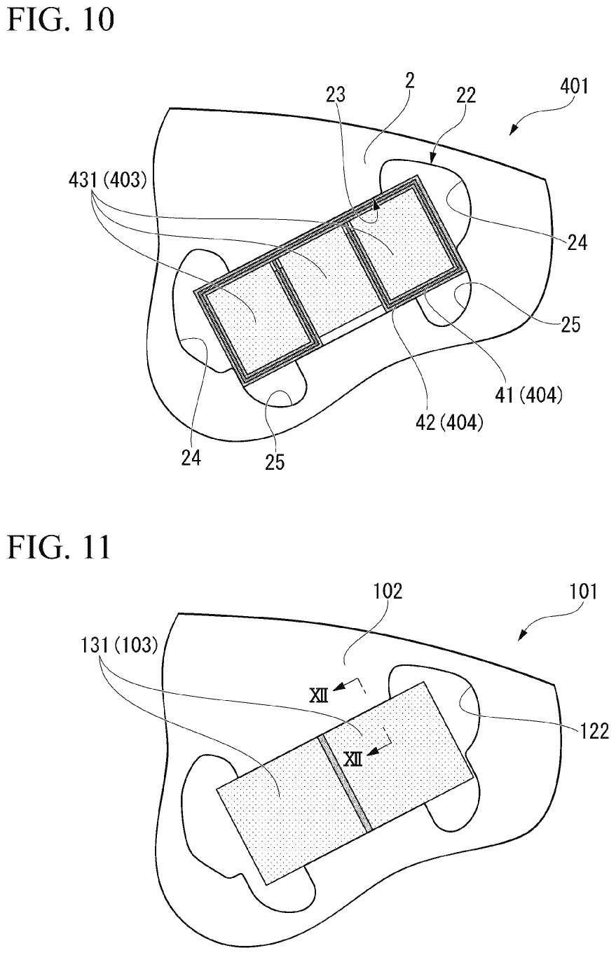

Next, a fourth embodiment according to the present invention will be described. FIG. 10 is a partially enlarged view of the vicinity of the magnet insertion slot 22 of a rotor 401 according to the fourth embodiment. The present embodiment is different from the above-described embodiments in that magnet pieces 403 include three single magnets 431.

In the present embodiment, the magnet pieces 403 are divided into three single magnets 431. Specifically, the magnet pieces 403 are divided into rectangular single magnets 431, 431, and 431 that are trisected in a longitudinal direction of the magnet pieces 403. In the following description, among the single magnets 431, one of the single magnets 431 disposed at both ends may be referred to as one single magnet 431, the other of the single magnets 431 disposed at both ends may be referred to as the other single magnet 431, and a single magnet 431 interposed between the one single magnet 431 and the other single magnet 431 may be referred to as an intermediate single magnet 431.

An insulating sheet 404 is wound around the magnet pieces 403. Inside the magnet insertion slot 22, the insulating sheet 404 is disposed between the magnet pieces 403 and the rotor core 2 and between the magnet pieces 403 adjacent to each other. Specifically, the insulating sheet 404 is wound around one single magnet 431 with one end portion thereof disposed on a dividing surface between the one single magnet 431 and an intermediate single magnet 431, and then is wound around the other single magnet 431 in a direction the same as the winding direction of the one single magnet 431, and the other end portion thereof is disposed on a dividing surface between the other single magnet 431 and the intermediate single magnet 431.

Thus, the insulating sheet 404 is disposed on outer circumferential portions of the one single magnet 431 and the other single magnet 431 and a portion of an outer circumferential portion of the intermediate single magnet 431.

According to the present embodiment, the same effects as those of the above-described embodiments are achieved, and it is possible to provide a high-performance rotor 401 in which occurrence of an eddy current is further inhibited.

Further, the technical scope of the present invention is not limited to the above-described embodiments, and various modifications can be made without departing from the spirit of the present invention.

For example, although a configuration in which the adhesive layer 42 has foamability has been described in the present embodiments, the present invention is not limited thereto. The sheet layer 41 may have foamability. In addition, the insulating sheet 4 may be formed of a single material having insulating properties, adhesiveness, and foamability.

The rotor core 2 may be a so-called dust core obtained by compression molding a metal magnetic powder (soft magnetic powder). However, the rotor 1 of the present embodiment is more effective for the case in which the rotor core 2 having a laminated structure in which an uneven shape is formed inside the magnet insertion slot 22 is used in that the magnet pieces 3 can be protected from the uneven shape by the insulating sheet 4.

The number of pieces and shapes of the magnet pieces 3, the number of magnet pieces 3 disposed with respect to the rotor core 2, or the like are not limited to the above-described embodiments.

Also, a winding method of the insulating sheet 4 is not limited to the above-described embodiments.

For example, the magnet pieces 3 may be divided into a plurality of pieces at predetermined positions in the axial direction. In this case, the insulating sheet 4 may be disposed between the magnet pieces 3 adjacent to each other in the axial direction. Thus, manufacturing of each of single magnets 31 and their arrangement in the rotor core 2 can be facilitated, the manufacturing cost of the rotor 1 can be reduced, and performance of the rotor 1 can be improved.

In addition, it is possible to appropriately replace constituent elements in the above-described embodiments with well-known constituent elements without departing from the subject matter of the present invention, and the above-described modified examples may be combined as appropriate.

What is claimed is:

1. A rotor comprising:
a rotor core having a magnet insertion slot;
a set of magnet pieces accommodated in the magnet insertion slot; and
a single insulating sheet wound around the magnet pieces,
wherein the insulating sheet is disposed between the magnet pieces and the rotor core and between the magnet pieces adjacent to each other, and
at least a portion of the insulating sheet has adhesiveness and foamability.

2. The rotor according to claim 1,
wherein the insulating sheet has a sheet layer which insulates the magnet pieces from the rotor core and the adjacent magnet pieces from each other, and an adhesive layer which bonds and fixes the magnet pieces to the rotor core and the adjacent magnet pieces to each other, and
the adhesive layer has foamability.

3. The rotor according to claim 2, wherein the adhesive layer is provided on a portion of the sheet layer.

4. The rotor according to claim 1, wherein the insulating sheet is wound in a B shape when viewed in an axial direction of the rotor core.

5. The rotor according to claim 1, wherein the insulating sheet is wound in an S shape when viewed in an axial direction of the rotor core.
